(19) United States
(12) Patent Application Publication
(10) Pub. No.: US 2008/0052746 A1
(43) Pub. Date: Feb. 28, 2008

(54) INTERACTIVE THEATER SYSTEM AND METHOD

(75) Inventors: STEVEN DE WAYNE COOPER, DES MOINES, IA (US); KRISTIAN ERIK ANDERSON, DES MOINES, IA (US); KIMBERLY KATHLEEN HUNTER, ORLANDO, FL (US); MARY BOOMS SELLERS, WEST DES MOINES, IA (US); BRENT LEE RUSSELL, PANORA, IA (US); VICTOR ALLEN BECKER, SANBORNVILLE, NH (US); GREGORY A. SPRICK, SOMERVILLE, MA (US)

Correspondence Address: MCKEE, VOORHEES & SEASE, P.L.C., 801 GRAND AVENUE, SUITE 3200, DES MOINES, IA, 50309-2721, US

(73) Assignee: SCIENCE CENTER OF IOWA, DES MOINES, IA (US)

(21) Appl. No.: 11/747,554

(22) Filed: May 11, 2007

Related U.S. Application Data
(60) Provisional application No. 60/800,112, filed on May 12, 2006.

(51) Int. Cl. H04N 7/173

(52) U.S. Cl. 725/80

(57) ABSTRACT

An interactive theater system and method having one or more computerized kiosks capable of running digital video clips. The kiosk allows a user to select one or more of the video clips for playing in a theater. A computer server is coupled to the kiosk and capable of communicating with the kiosk and capable of monitoring operation of the kiosk. A theater video system is coupled to the server and plays the selected video clips in the theater.

### CROSS-REFERENCE TO RELATED APPLICATIONS

This application claims priority under 35 U.S.C. §119 of Provisional Application Ser. No. 60/800,112 filed May 12, 2006, which application is hereby incorporated by reference in its entirety.

### BACKGROUND OF THE INVENTION

The present invention relates to an interactive theater system and method where theater guests can create and play a digital video presentation in a theater, without assistance from a theater employee or staff person.

Planetarium/star theaters are generally used only when there is a scheduled formal presentation. However, this is inefficient use of the facilities. Most facilities only open the theater doors 5 or 6 times a day to run short presentations, typically only ½ hour in length.

A few places have addressed the first facility usage issue by simply leaving the doors open while a presenter gives the same speech over and over all day, every day. This can be boring for return visitors. Some places have installed direction controls into the seats of their theater. This is not feasible for some theaters.

In view of the foregoing, the primary objective, feature and advantage of the present invention is an improved interactive theater system and method.

A further objective, feature and advantage of the present invention is an interactive theater allowing guests to create their own video presentation for display in the theater.

A further objective, feature and advantage of the present invention is a provision of an interactive theater system and method which is economical to manufacture, durable in use and efficient in operation.

Another objective, feature and advantage of the present invention is to put control of the theater into the hands of it's guests.

Still another objective, feature and advantage of the present invention is the provision of a system and method for visitors or guests to use the theater to watch videos personally selected from a video library without assistance or intervention by a theater employee or staff person.

One or more of these and/or other objects, features or advantages will become apparent from the specification and claims that follow.

### BRIEF SUMMARY OF THE INVENTION

On the exhibit floor outside the Star Theater there are one or more computer kiosk stations, each with a touch screen computer monitor and a larger video screen, such as an LCD video screen. The monitor lists a menu of short video clips on a given topic, such as ‘Living with a Star’. Touching a clip selection highlights it and plays a small piece of the clip in a window on the screen, and offers a brief description of the contents.

If a guest sees a clip he or she likes, they ‘add’ it to a list of their selections along the bottom of the screen. Once they have selected 4 or 5 clips, they are encouraged on the screen to touch the ‘play’ icon. Doing so brings up a screen listing the guest's selections and begins playing short video sequences on the attached LCD screen.

Once the sequences have completed, the guest is asked if he or she would like to see the full production of their selections on a dome in a Star Theater. If they respond ‘yes’, they are given a show number. They can then enter the Star Theater, enter their number on a touch screen or other remote control device and their show begins to play on the dome surface in the theater.

There are three main components to the interactive theater system of the present invention: an interactive theater system kiosk station, an interactive theater system server, and a digital theater projection system.

The interactive theater system kiosk is a basic PC powerful enough to run the video and audio clips, a 17-inch touch screen monitor, a 40-inch LCD panel, and a pair of PC speakers. The preferred software used to create the interactive theater system is Macromedia Flash™ and Macromedia Director™.

The interactive theater system server is a basic PC running a number of off-the-shelf packages, like Apache™ and SQL™. The three systems need to be able to communicate the needed data to make the interactive theater system possible. The server acts as a monitor for the kiosks. A server is needed as a go-between for the kiosks and the all-dome system. The kiosks query the server to see if it is okay to offer a show to the guests, the server determines the number of the guest's shows, and writes the script for the digital theater projection system to run that show in the theater. A preferred digital theater projection system is a Digistar 3™ system.

Digistar 3™ is a full dome projection system. There are eight PCs networked together. One acts as the system host, one runs the audio for the theater, and each of the remaining six are attached to a video projector. The result is video imagery meshed together to fill the entire dome. The Digistar 3™ system plays back the full production sequences of the kiosk clips, but uses the entire theater dome to do so. It reads the scripts created on the interactive theater system server.

It is preferable that the shows be assembled or selected outside the theater, so that others in the theater do not have to sit around waiting for a show. The interactive theater system can be developed using Macromedia Director™ and Flash™.

### BRIEF DESCRIPTION OF THE DRAWINGS

FIG. 1 is a schematic view of one embodiment of the interactive theater system of the present invention.

FIG. 2 is a schematic view of one embodiment of the computer station/kiosk shown in FIG. 1.

FIG. 3 is a schematic view of one embodiment of the computer server shown in FIG. 1.

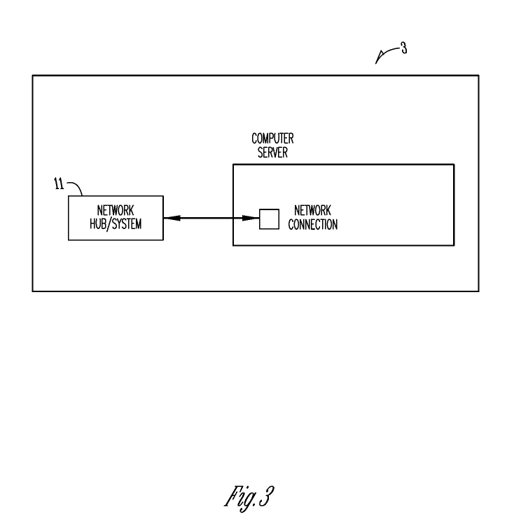

FIG. 4 is a sample menu screen for the touch screen monitor of the kiosk for the present invention in an initial configuration of allowing a user to select video clips from a video library.

FIG. 5 is a sample screen for the touch screen monitor of the kiosk in a subsequent configuration after the user selected the desired video clips.

FIG. 6 is another sample screen for the touch screen monitor of the kiosk showing a further configuration after the viewer has previewed the selected video clips.

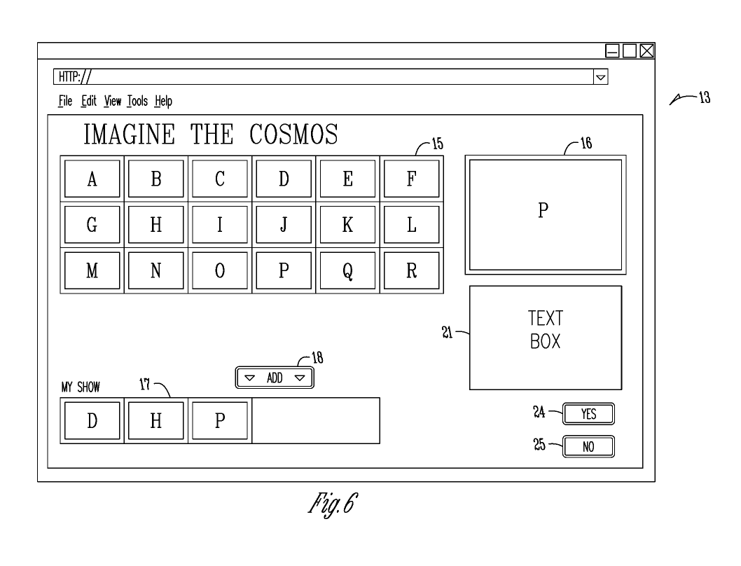

FIG. 7 is a schematic flow chart of the interactive method for playing videos according to the present invention.

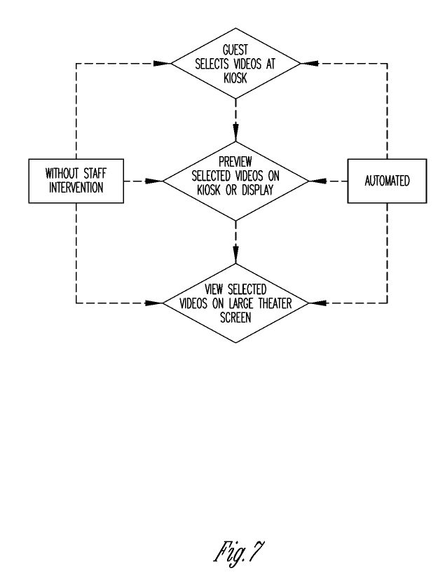

### DETAILED DESCRIPTION OF THE PREFERRED EMBODIMENT

The present invention is a mechanism by which visitors to a digital theater can preview the resources available for presentation, assemble a number of these resources into their own custom “show,” and then enter the theater and immediately view their selections.

This interactive theater system 1 is an interactive presentation system which allows guests (users) to have control of the assembly, activation, and implementation of digital (visual and audio) media from any number of video clips from a video library so as to create a custom designed program for a visual/audio presentation system.

Part 1: The Interactive Theater System Production/Presentation System.

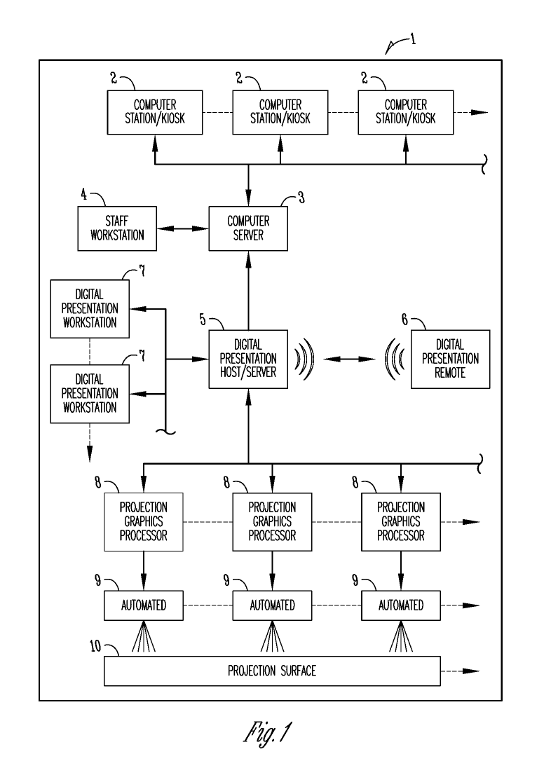

FIG. 1, as a whole, represents the interactive theater system 1. The three key components to the system are the interactive theater system station/kiosk 2, the interactive theater system server 3, and the digital presentation host/server 5-10.

Part 2: The Interactive Theater System Station/Kiosk.

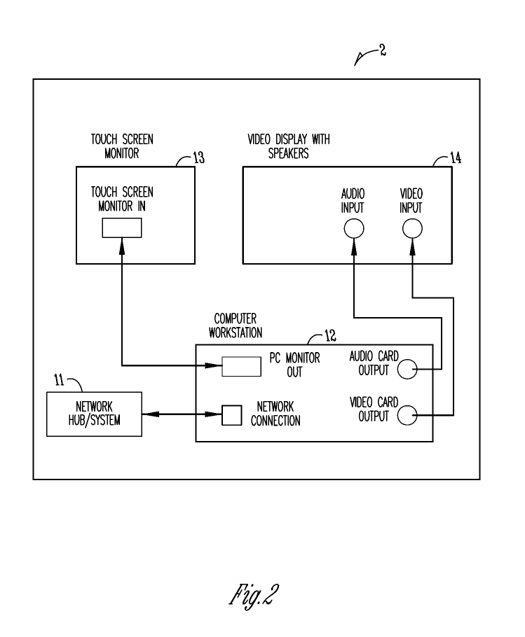

Shown in FIG. 2, each kiosk (or workstation) generally has three parts giving the user access to the resources available to create their own presentation. Those three parts are a computer workstation 12, a touch screen monitor 13, and a video display unit with speakers 14. There can be any number of Interactive theater system stations/kiosks 2 located anywhere in a room, throughout a facility, or even remotely.

Another hardware component is a network hub/wireless/system 11. This part can vary in form and function from a direct link (LAN), to a multi-port hub (router or switcher). The network hub 11 is optional, however, the Kioski/Station 2, without the network hub 11, will function as a stand alone presentation device. The kiosk/station 2 requires the network hub 11 in order to communicate with the interactive theater system server 3, which will in turn create the productions for the digital presentation host/server 5-10.

Part 3: The Interactive Theater System Server.

The interactive theater system’ server 3 is a basic PC system. It does not require any special hardware considerations for performance. The server 3 should have a connection to a Network hub/wireless/system 11.

This PC acts as the ‘link’ between the interactive theater system stations/kiosks 2, the staff workstations 4, and the digital presentation host/server 5. For the interactive theater system stations/kiosks 2, software provides a status of the availability of the digital presentation system 5-10 for library submissions, and the information the user needs to view their video clip library selections on the digital presentation system 5-10. The server software will accept the list of library selections made by the user and assemble them into a presentation executable by the digital presentation host/server 5.

Part 4: The Staff Workstations.

Access to the server 3 from a staff workstation 4 is recommended, but not required. This link allows producers to submit new selections to the library, update the data-base for the video library, control the availability of the digital presentation system 5-10, and provide access to other utilities staffoperators might deem useful (a show counter, list of resources, etc.). A monitor, keyboard, and mouse or other I/O devices are only required for basic PC maintenance and up keep.

Other than a connection to a Network hub/wireless/system 11 to make use of the utilities provided by the interactive theater system server 3, there are no specific requirements for the workstation.

Parts 5 thru 10: Digital Presentation System.

There are only two requirements for any digital presentation system to make use of the interactive theater system. One is the ability to communicate with the Interactive theater system server 3 via a network hub/wireless/system 11. The other is the ability to execute programming that resides on a third party computer, specifically the interactive theater system server 3.

FIG. 1 shows one example of a digital presentation system. In this instance, a host/server 5 executes the programming provided by the interactive theater system server 3, and also controls an unspecified number of projector graphics processors 8. These projector graphics processors 8 in turn each feed the visuals and/or audio to a projector 9 which displays the results on a projection surface 10, which may be any configuration, including flat, curved, or domed.

The digital presentation remote control device 6 and digital presentation computer workstation 7 are examples of components of a digital presentation system that can trigger events (programming), such as starting or stopping a show on the digital presentation host/server 5. This would include accessing the programming provided by the interactive theater system server 3.

The interactive theater system is by no means limited to this particular arrangement. It is possible the digital presentation host/server 5 serves as the projector graphics processor 8 as well, or there may be no workstations 7, or any number of combinations involving these and other elements.

Part 11: Network Hub/Wireless/System.

As with the digital presentation system, this component is non-brand specific. It can be any method of communication which the developer chooses to use for the network. This includes, but is not exclusive to routers, switchers, hubs, and network PC management systems. Other than the basic configuration setup requirements for a network, there are no custom needs to make the interactive theater system 1 function. It is not even required that this Network component be particularly fast.

Part 12: The Interactive Theater System Workstation (PC).

The form of this computer workstation 12 is non-specific (independent of brand of motherboard, hard drive, graphics card, RAM, etc . . . ). The function, however, is very important. The PC must be assembled to handle a large amount of visual and audio through-put. Specifically, it needs to be fast, have a large amount of RAM, and a large hard drive storage space. It needs to have two video outputs, one for the touch screen 13 and one for the video display 14. The second video display 14 should also have audio output as well. If the workstation is to be used to create presentations for a digital presentation system 5-10, it must have a port for the Network hub/wireless/system 11 or other networking capabilities as well. A mouse and keyboard are needed for basic up keep of the PC.

The PC will hold the software, video, and audio material allowing the user to preview, select, and assemble the material from the audio/video clip library.

The presentation software on this PC needs to be able to communicate with the Interactive theater system server 3 via the Network hub/wireless/system 11 to query the availability of the digital presentation system 5-10 for presentation, retrieve the information the user needs to activate their presentation on the digital presentation host/server 5 (e.g. a ‘show number’), and submit a list of the video library selections the user wishes to display. The connection with the network hub 11 does not have to be wireless.

Part 13: A Touch Screen Monitor.

Though the screen 13 does not have to be a touch screen, it is recommended. Removing the mouse and keyboard from the hands of the user removes opportunities to escape from, and then damage, the software components of the package. However, any I/O devices can be used with this system. The recommended optimal resolution for the screen is 1280 by 1024 pixels, though that can vary. The recommended optimal size for the screen is 19 inches, though that can vary as well.

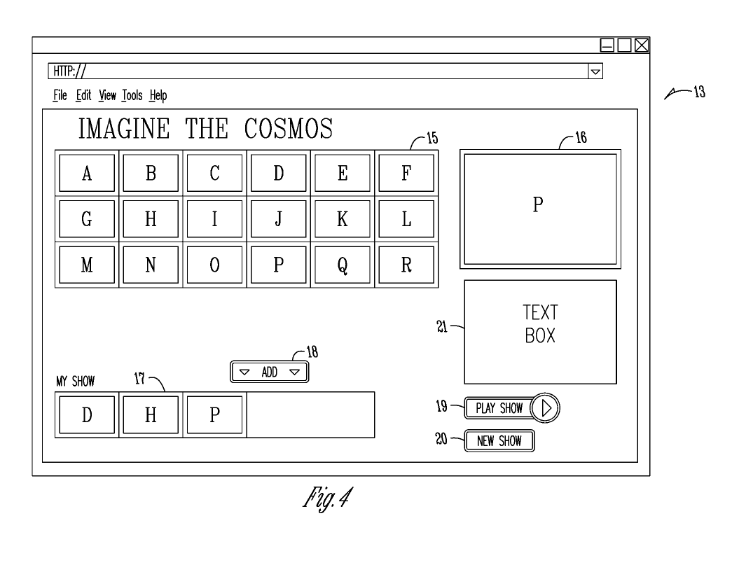

This screen is where the user selects and assembles their choices from the video library. This is also where the user is given the option to submit their presentation for display on the digital presentation system 5-10. A sample screen for the monitor 17 is shown in FIG. 4.

Part 14: A Video Display Monitor With Speakers.

This display should be a larger video display screen, with audio inputs. Speakers independent of the screen are possible. The recommended optimal size for the screen is 40 inches, but can be adjusted to fit the environment. The recommended optimal resolution is 1024 by 768 (S-Video quality).

This screen 14 is where the user views brief presentations of the audio/video clip library choices they have made.

Interactive Theater System Stations/Kiosks

There can be any number of interactive theater system stations 2. These stations 2 can each function as a stand-alone kiosk or, via a standard network connection 11, be made available to submit sequences to be viewed in the theater. Each station has three hardware components: a PC 12, a computer monitor 13, and a display screen 14.

The PC 12 must be assembled to allow for high resolution graphic capability on the monitor 13, and for output to a quality display screen 14. The PC 12 must have enough speed, RAM, and capacity to display media on both the monitor and display smoothly. All media for display are in digital form and stored on the PC 12 itself. The graphics card installed on the PC 12 should allow for dual display. The station should have a network connection to allow communication with the interactive theater system server if “shows” are to be submitted for viewing in the digital theater; however, the station can function as a stand alone kiosk without that connection. A preferred computer is a Hewlett Packard™ u5000 with a 3.2 GHz Processor, 1 GB of RAM, an 80 GB hard drive, and an Intelυ 82865G graphics card.

The monitor 2 must be capable of displaying the visuals described in the “User Experience” section in a clean, professional manner. The monitor can be a touch screen or require standard methods of input for interactive theater system interaction (mouse, keyboard, track ball, etc.). A preferred device is a 19-inch touch screen monitor.

The display screen 14 can be either PC-based (RGB, DVI, etc.) or video-based (composite, s-video, component, etc.), as long as it is compatible with the graphics card assembled into the PC 12. A preferred display is a 40-inch Sony flat screen LCD display.

The software on the PC 12 must allow for interaction by the user, enable the display of standard digital media formats (stills such as Jpg, bmp, etc., and video such as QuickTime™ and MPEG), and be capable of communicating with the interactive theater system server 3. Macromedia Flash™ and Director™ are examples which meet these requirements. One example of a database used by this presentation has 19 topics to choose from. The software allows addition and removal of topics at will.

Interactive Theater System Server

There is only one interactive theater system server PC 3 required. Any number of interactive theater system kiosk/stations 2 can be used. The server 3 has two purposes—to provide communication within the interactive theater system 1 and to provide data for the digital projection system 5.

The server 3 has a number of simple utilities allowing the system operators to modify the data required to make it possible to assemble the presentations for the digital projection system 5-10, including a data set with the names of the topics on the interactive theater system stations 2 and the names of the lengths of their counterparts for the digital projection system 5-10. The communication between server 3 and station 2 is two way.

When a user at a station selects “Play Show” and has selected the minimum number of topics or video clips to view (such as four), it will query, or “ask” the server 3 if the digital projection system is in “theater” mode. This is a simple matter of looking at the value of a status file, “1” means yes, and “0” means no. The station 2 uses this information to determine if it will inform the user of the option to submit a theater show. If the answer was “no,” the station 2 will function as a stand-alone kiosk. This “theater” mode status can be turned on or off using the utility on the server 3.

After a user has finished previewing their show and answers “yes” to the option to view it in the theater, the station sends a list of the clips selected to the server and requests a show number to display to the user. The server provides that show number, then uses the list to assemble a text script for the digital projection system 5. The server 3 merely provides the file the theater server 5 reaches out to and runs.

The server 3 is a basic off-the-shelf PC and requires very little speed or capacity. Monitor, keyboard, and mouse are only required for PC access, not to function as the interactive theater system server 3.

The software on the server 3 for communication can be anything designed to handle network communication and data management. The preferred software is a combination of Apache™, PHP™, and SQL™. These are not custom packages. The software developed for the servers to function as the interactive theater system server is custom software, which can be written by a programmer having ordinary programming skill so as to provide the desired functions.

Digital Projection System

The digital projection system 5 can be any digital system, such as Digistar from Evans and Sutherland, Electric Sky from Spitz, Digital Sky from Sky Skan or even other forms of multi-visual display systems (e.g. a video wall, etc.). The only requirement is that the projection system be able to access the interactive theater system server 3 to retrieve the source code that has been assembled there.

The communication between server 3 and system 5 can be set up to allow the server 3 to have access to the system 5. The preferred system uses a Digistar 3 system from Evans and Sutherland, which is behind a firewall that does not allow the server 3 access. Therefore, the communication is only one-way. The projection system 5-10 has the capability to display the video clips on a large viewing surface, such as a dome theater. The preferred projection system uses six projectors which merge images to make a single, large image in a dome theater.

The User Experience

The user sits or stands in front of a kiosk display system 2 with two display screens 13, 14. One is a computer touch screen 13, the other is an LCD flat screen TV 14. The touch screen 13 can be replaced by a normal monitor requiring an input device (mouse, keyboard, track ball, etc.). The size of either display device 13, 14 can be adjusted.

If the system has been more than a few minutes without use, a message such as “Make your own Star Theater show,” can be scrolling upward on the large display 14, and a message such as, “Touch screen to begin,” can be displayed on the smaller touch screen 13. This will “wake up” the software.

On the touch screen 13 is a caption, such as, “Imagine the Cosmos.” This caption can be modified to convey any desired message. Below this message and on the left side of the screen is a grid of small images 15, such as those labeled A-R in FIG. 4. In a preferred embodiment, each image box A-R measures roughly 110 horizontal pixels by 80 vertical pixels. The number of images may vary. The images represent topics or video clips available in a video library for display in the large digital theater system. To the right of the grid is a preview window 16 for viewing short segments of the video clips selected, such as clip P as shown in FIG. 4. The number of rows and columns, as well as the dimensions of the images and the box can be modified to suit.

Along the bottom of the screen there are two parts. On the left is a single row of space 17 with room to fit a number of selected images from above. A caption above this row can read “My Show”. There is also a button 18 labeled, “Add”. Also on the screen there can be two buttons, one 19 labeled, “Play Show,” and the other 20 labeled, “New Show” (not shown). The user is instructed to touch any of the images A-R on the grid 15. Doing so causes a “highlight” box to appear around the selected image. In FIG. 4, clips D, H and P have been selected. The larger box 16 on the right displays a “preview” of the selected topic (clip P in FIG. 4). There is no audio on this preview, but there can be audio on the preview, if desired. Text describing this topic appears in an area 21 below the preview box. If the user wants to learn more on this topic, touching the “Add” button 18 removes the picture from the grid 15 and places it in the “My Show” row 17 along the bottom. The user can then highlight, preview, and add any number of clips A-R of his/her choosing to the “My Show” row 17. The system may be arranged differently and may allow for a different or limited number of clips to be chosen.

Any time a user changes his/her mind about a clip they have chosen, it can be highlighted in the “My Show” row 17 which switches the “Add” button 18 to “Remove.” Touching “Remove” returns the image to the grid 15. The “New Show” button 20 in the lower right corner removes all of the selected images at once. As with the grid 15, the limit on the number of selections for the “My Show” row 17 can be adjusted.

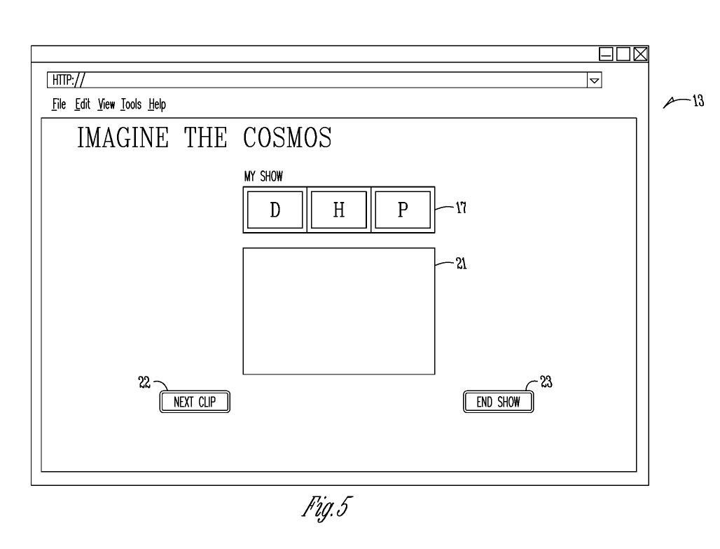

As long as there is at least one image in the “My Show” row 17, the user can select “Play Show” which affects both the touch screen 13 monitor and the LCD display 14. As seen in FIG. 5, the touch screen 13 removes the grid, preview window, and the “Add/Remove,” “Play Show,” and “New Show” buttons. The “Imagine the Cosmos” caption remains across the top of the screen 13, while the “My Show” caption and the row 17 of selected topics moves up to the center of the screen. Along the bottom of the screen there are now two buttons, one 22 reads, “Next Clip,” while the other 23 reads, “End Show”.

If the user has selected more than three clips, a brief message appears on the LCD display 14 stating, “Congratulations! Your show will begin shortly.” This message does not appear if the user has not selected more than three images, or if it is not connected to the interactive theater server 3. This number of clips may be more or less than three.

A highlight box will appear successively around each of the selected images (D, H, J, P) in row 17 on the touch screen 13, progressing from left to right. As each image is highlighted, the text description from the previous page appears below the row 17, and a slightly longer visual, including audio, is displayed on the LCD screen 14. As each visual on the LCD display 14 finishes, the highlight box on the touch screen 13 moves to the next image.

After the visual for all the selected topics have been displayed, and if the user has selected no more than three images or the station is not connected to the interactive theater system server 3, the touch screen 13 will automatically return to the menu screen. The screen 14 also returns to the main menu if the station is again not connected to the server 3. If the user has selected more than three images or video clips, the LCD screen 14 displays the message, “Thank you for participating! To see your show on the dome, enter ‘yes’ on the touch screen.” The touch screen 13 then displays the message “Congratulations! Your show was great! Would you like to see it on the dome in the Star Theater?” Two buttons then appear with one 24 saying, “Yes”, and the other 25 “No”. The number of clips required for a theater prompt, currently set at three, can be modified.

Selection “No” returns the user to the menu screen of FIG. 4. Selection “Yes” replaces the touch screen message with “Your show number is XXX” (a number selected by the interactive theater system server 3). To watch this show, go into the Star Theater and enter your number on the control panel 6. There is a “New Show” button in the lower right corner which once again returns the user to the menu screen.

The user then enters the Star Theater. The user enters the show number they were given at the interactive theater system station 2. Then, on the control panel 6, the lights in the theater fade out, the user watches the video clips they have selected in the order they have chosen. After the last video clip, the theater lights fade up and the theater is ready for the next user.

The flexibility of the system allows for many variations in the implementation of the interactive theater system. One example is to allow for more than one “page” of options with an “index” page. The user might see a choice of topics ranging from astronomy to zoology to biology, then flip to a menu list on that topic. A second example would be to place a kiosk in the theater itself and run the video clips as they are selected.

Once the theater system of the present invention is set up, its use is completely automated based upon the interactive input from the user/visitor/guest, with no requirement for intervention or assistance from a theater staff or employee. The user, guest or visitor can simply walk up to the kiosk, follow the menu of directions for selecting, previewing, and saving videos from the video library, and then watch the selected videos on the theater screen, which preferably is in a different room from the kiosk. Multiple kiosk users will have their video selections queued for sequential playing at the theater. Each user will have a specific show number assigned to their selection, so the user can enter the show number in the presentation remote 6 when they enter the theater to watch their video clips on the theater screen 10.

It is understood that staff or employee assistance may be provided for young children or other guests who do not understand the operation of the system.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. An interactive theater system, comprising:
a computerized kiosk capable of running digital video clips, the kiosk allowing a first user to input a selection of one or more of the video clips from a video library;
a computer server operatively coupled to the kiosk for communicating with the kiosk and monitoring operation of the kiosk; and
a theater video system operatively coupled to the server for playing the selection of the video clips in a theater.

2. The theater system of claim 1 wherein the theater is a dome theater.

3. The theater system of claim 1 further comprising multiple digital video projectors for playing the video clips in the theater.

4. The theater system of claim 1 wherein the kiosk, server, and video system operate without any theater staff intervention.

5. The theater system of claim 1 wherein the kiosk, server, and video system operate automatically.

6. The theater system of claim 1 further comprising a display monitor associated with the kiosk for previewing the video clips of the library.

7. The theater system of claim 6 further comprising a second display monitor associated with the kiosk for viewing of the selected video clips.

8. The theater system of claim 1 further comprising a second computerized kiosk operatively connected to the server and to the video system for playing video clip selections of a second user in the theater following playing of the first user's selected video clips.

9. The theater system of claim 8 wherein the server queues the first and second user's selected video clips for playing in the theater.

10. A method of playing video clips in a theater comprising:
allowing a first theater guest to select one or more digital video clips from a library of digital video clips using a computer;
previewing the selected video clips on a monitor associated with the computer;
inputting a request to view the selected video clips in a theater; and
playing the selected video clips in the theater for viewing by the guest.

11. The method of claim 10 wherein selection, previewing and playing of the video clips is accomplished by the guest without assistance from a theater staff person.

12. The method of claim 10 wherein the selection, previewing and playing of the video clips occurs without any theater staff intervention.

13. The method of claim 10 wherein the videos are played using multiple projectors.

14. The method of claim 10 wherein the selection and playing of videos are in separate rooms.

15. The method of claim 10 wherein the computer is remote from the theater.

16. The method of claim 10 wherein the selections of videos can be modified by the guest.

17. The method of claim 10 further comprising allowing a second theater guest to select one or more video clips from the library using a second computer, and playing the video clips selected by the second guest in the theater following playing of the first guest's selected video clips.

18. The method of claim 17 wherein the second guest's selected video clips are automatically queued for playing in the theater.

19. A method of playing videos in a theater, comprising:
multiple user's each selecting customized sets of videos from a digital video library using multiple computer stations;
transmitting data regarding each set of videos to a server to order the sets for viewing;
projecting each set of videos in order on a theater screen in a room separate from the computer stations.

20. The method of claim 1 wherein the transmitting and projecting steps are accomplished automatically without intervention by a theater staff person.
